(19) United States
(12) Patent Application Publication
(10) Pub. No.: US 2020/0346415 A1
(43) Pub. Date: Nov. 5, 2020

(54) FASTENER STRUCTURE OF FIXING COMPONENT AND THE FIXING COMPONENT

(71) Applicant: DTECH PRECISION INDUSTRIES CO., LTD., New Taipei City (TW)

(72) Inventor: TING-JUI WANG, NEW TAIPEI CITY (TW)

(21) Appl. No.: 16/934,199

(22) Filed: Jul. 21, 2020

Related U.S. Application Data
(63) Continuation-in-part of application No. 15/352,707, filed on Nov. 16, 2016.

(30) Foreign Application Priority Data
Nov. 20, 2015 (TW) 104138651

(51) Int. Cl. B29C 65/42; F16B 5/02; F16B 3/00; B29C 65/00

(52) U.S. Cl. CPC B29C 65/42; B29C 66/43; F16B 3/005; F16B 5/0208

(57) ABSTRACT

A fastener structure of a fixing component includes a joining element and a corresponding element, with the joining element fitted to the corresponding element. A fixing component includes an engaging-connecting element and a fastener structure. The engaging-connecting element has a head portion, fitting portion and engaging-connecting portion which are sequentially connected, with the fitting portion fitted to the joining element. A fitting method for manufacturing the fastener structure and the fixing component involves fitting the joining element to the corresponding element, pressing and fitting the fitting portion of the engaging-connecting element into an insertion portion of the joining element, and movably engaging-connecting the first inner engaging portion of the corresponding element to an outer engaging portion of a fixing element from outside.

### CROSS-REFERENCE TO RELATED APPLICATION

This application is a continuation-in-part patent application of U.S. application Ser. No. 15/352,707, filed on Nov. 16, 2016, which claims priority to Taiwanese Application No. 104138651, filed on Nov. 20, 2015, the entire contents both of which are hereby incorporated by reference for which priority is claimed under 35 U.S.C. § 120.

### BACKGROUND OF THE INVENTION

### 1. Field of the Invention

The present disclosure relates to a fastener structure of a fixing component and the fixing component, and in particular to a fixing component manufactured from a simple structure and by a simple fitting method.

### 2. Description of the Related Art

Conventional fixing components are for use in coupling at least two objects together and thus are usually difficult to manufacture. Therefore, it is important to provide a fastener structure of a fixing component and the fixing component, such that the fixing component is manufactured from a simple structure and by a simple fitting method.

### BRIEF SUMMARY OF THE INVENTION

An objective of the present disclosure is to provide a fastener structure of a fixing component and the fixing component, such that the fixing component is manufactured from a simple structure and by a simple fitting method.

To achieve at least the above objective, the present disclosure provides a fastener structure of a fixing component, comprising a joining element and a corresponding element, the joining element being fitted to the corresponding element, wherein the joining element is for use in fitting the engaging-connecting element in place.

In the fastener structure of the fixing component, the corresponding element is a cylinder, or the joining element and the corresponding element are fitted together to form a cylinder. The cylinder has a receiving space.

In the fastener structure of the fixing component, the corresponding element has a first inner engaging portion movably engagingly-connected to a fixing element.

In the fastener structure of the fixing component, the first inner engaging portion has a first pressing surface. The first pressing surface is a flat surface, oblique surface, curved surface or arcuate surface.

In the fastener structure of the fixing component, the first inner engaging portion has a first engagement depression whereby the first inner engaging portion is capable of movably engaging-connecting with the fixing element.

In the fastener structure of the fixing component, the first inner engaging portion is a resilient plastic element.

In the fastener structure of the fixing component, the corresponding element has a plurality of engaging members whereby the corresponding element is capable of movably engaging-connecting with the fixing element.

In the fastener structure of the fixing component, an outer peripheral surface of the corresponding element is a smooth surface or has a three-dimensional pattern, teeth or gear rack.

In the fastener structure of the fixing component, the joining element has an insertion portion insertedly fixed to the engaging-connecting element.

In the fastener structure of the fixing component, the insertion portion of the joining element has an upper raised portion, lower raised portion, upper dented portion or lower dented portion.

In the fastener structure of the fixing component, an outer peripheral surface of the joining element has a three-dimensional pattern, teeth, gear rack, dented portion, raised portion, flat surface, oblique surface, curved surface or arcuate surface so as to be fitted to the corresponding element.

In the fastener structure of the fixing component, an outer peripheral surface of the joining element is circular or has sides which are in an odd number or in an even number so as to be fitted to the corresponding element.

In the fastener structure of the fixing component, an upper portion, a lower portion and a lateral portion of the joining element is fitted to the corresponding element, or the upper portion of the joining element is fitted to the corresponding element, or the lower portion of the joining element is fitted to the corresponding element, or the lateral portion of the joining element is fitted to the corresponding element, or the upper portion and the lower portion of the joining element are fitted to the corresponding element, or the upper portion and the lateral portion of the joining element are fitted to the corresponding element, or the lower portion and the lateral portion of the joining element are fitted to the corresponding element.

In the fastener structure of the fixing component, the corresponding element is fitted to the joining element by plastic insert molding.

In the fastener structure of the fixing component, the corresponding element is fitted to the joining element by hot fusion, riveting, expansion, adhesion, screwing or welding.

In the fastener structure of the fixing component, the joining element is made of plastic or metal, and the corresponding element is made of plastic or metal.

The fastener structure of the fixing component further comprises a die, the die having a feed port and a corresponding element receiving space which are in communication with each other, the joining element being disposed in the die and connected to the corresponding element receiving space, wherein a plastic liquid is introduced into the feed port and the corresponding element receiving space so as for the corresponding element to be fitted to the joining element.

In the fastener structure of the fixing component, the die is pressed between the joining element, an insertion portion of the joining element, and the corresponding element to stop the plastic liquid introduced into the corresponding element receiving space from overflowing, flowing into or entering the insertion portion or vicinity of the insertion portion.

The fastener structure of the fixing component further comprises a carrier for receiving the fastener structure. The carrier is a tray or a band.

The fastener structure of the fixing component further comprises an auxiliary fetching body disposed on the fastener structure.

In the fastener structure of the fixing component, the carrier has a cover for covering the fastener structure.

The fastener structure of the fixing component further comprises an operating element. The joining element has an insertion portion. The insertion portion of the joining element is fitted to the operating element or the engaging-connecting element.

In the fastener structure of the fixing component, the engaging-connecting element or the operating element has a riveting portion riveted to the joining element.

In the fastener structure of the fixing component, the joining element has a corresponding guiding portion corresponding in position to the operating element or the engaging-connecting element. The operating element or the engaging-connecting element has a guiding portion. The corresponding guiding portion guides the guiding portion, so as to guide the operating element or the engaging-connecting element to fit to the joining element.

The fastener structure of the fixing component further comprises the fixing element. The corresponding element, the engaging-connecting element or the joining element is movably fitted to the fixing element.

In the fastener structure of the fixing component, the insertion portion of the joining element is a raised portion and is inserted into the engaging-connecting element.

In the fastener structure of the fixing component, the joining element has a guiding portion, and the engaging-connecting element has a corresponding guiding portion for use in alignment, guidance, and fitting.

In the fastener structure of the fixing component, the engaging-connecting element is formed by fitting the body portion and the engaging portion together.

In the fastener structure of the fixing component, the joining element or the engaging portion has a riveting portion riveted to the engaging-connecting element or the body portion.

In the fastener structure of the fixing component, the fixing element is movably fitted to the corresponding element, the engaging-connecting element, the engaging portion or the body portion.

In the fastener structure of the fixing component, the engaging-connecting element is formed by fitting the body portion and the engaging portion together, and the body portion has a corresponding guiding portion, wherein the engaging portion has a guiding portion for use in guidance and fitting.

The present disclosure further provides a fixing component which comprises an engaging-connecting element and the fastener structure, wherein the engaging-connecting element has a head portion, fitting portion and engaging-connecting portion which are sequentially connected, with the fitting portion fitted to the joining element.

The present disclosure further provides a fastener structure of a fixing component, comprising a joining element and a corresponding element, the joining element being fitted to the corresponding element and having an engaging-connecting portion.

The present disclosure further provides a fastener structure of a fixing component, comprising a joining element and a corresponding element, the joining element being fitted to the corresponding element.

In the fixing component, the head portion is higher than, flush with or lower than the top surface of the corresponding element.

In the fixing component, the periphery of the head portion is an oblique surface, arcuate surface or curved surface.

In the fixing component, the die is pressed between the joining element, the head portion and the corresponding element to stop the plastic liquid introduced into the corresponding element receiving space from overflowing, flowing into or entering the head portion or the head portion.

In the fixing component, the joining element and the engaging-connecting element are integrally formed, or the joining element and the engaging-connecting element are fitted together.

In the fixing component, the die is pressed between the head portion and the corresponding element to stop the plastic liquid introduced into the corresponding element receiving space from overflowing, flowing into or entering the head portion or the vicinity of the head portion.

In the fixing component, an outer peripheral surface of the fitting portion has a three-dimensional pattern, teeth, gear rack, dented portion, raised portion, flat surface, oblique surface, curved surface or arcuate surface so as to be riveted, engaging-connected, expanded, screwed, welded, adhered or hot-fused to the joining element.

In the fixing component, the engaging-connecting element and the joining element are integrally formed.

In the fixing component, the engaging-connecting element and the joining element are integrally formed by lathing, forging, stamping, plastic injection or metal injection.

In the fixing component, the engaging-connecting element, the joining element and the corresponding element are integrally formed.

In the fixing component, the engaging-connecting element, the joining element and the corresponding element are integrally formed by lathing, forging, stamping, plastic injection or metal injection.

In the fixing component, the engaging-connecting portion is an outer thread, inner thread, external fastener, internal fastener or post.

In the fixing component, the joining element, the corresponding element and the engaging-connecting element are fitted together to form a module.

In the fixing component, the joining element and the engaging-connecting element are integrally formed, and the corresponding element is fitted to the joining element by plastic insert molding.

The fixing component further comprises a carrier for receiving the fixing component, and the carrier is a tray or a band.

The fixing component further comprises an auxiliary fetching body disposed on the fixing component.

In the fixing component, the carrier has a cover for covering the fixing component.

The fixing component further comprises a fixing element movably fitted to the engaging-connecting element or the corresponding element.

In the fixing component, the fixing element has an outer engaging portion movably engagingly-connected to the first inner engaging portion of the corresponding element.

In the fixing component, the outer engaging portion has a second engagement depression movably engagingly-connected to the first inner engaging portion of the corresponding element.

In the fixing component, the outer engaging portion has a flat surface, oblique surface, curved surface or arcuate surface.

In the fixing component, the fixing element has a fixing portion riveted, engaging-connected, expanded, screwed, welded or adhered to an object.

In the fixing component, the joining element, the corresponding element, the fixing element and the engaging-connecting element are fitted together to form a module.

In the fixing component, the joining element, the corresponding element, the fixing element, the engaging-connecting element and an object are fitted together to form a module, and the object is fitted to the fixing element.

In the fixing component, the fixing element has a second inner engaging portion movably fitted to the engaging-connecting element.

The fixing component further comprises a carrier for receiving the fixing component, and the carrier is a tray or a band.

The fixing component further comprises an auxiliary fetching body disposed on the fixing component.

In the fixing component, the carrier has a cover for covering the fixing component.

The fixing component further comprises a resilient element with one end pressing against the joining element or the corresponding element and another end pressing against the fixing element.

In the fixing component, the joining element, the corresponding element, the fixing element, the engaging-connecting element and the resilient element are fitted together to form a module.

In the fixing component, the joining element, the corresponding element, the fixing element, the engaging-connecting element, the resilient element and an object are fitted together to form a module, and the object is fitted to the fixing element.

The fixing component further comprises a carrier for receiving the fixing component, and the carrier is a tray or a band.

The fixing component further comprises an auxiliary fetching body disposed on the fixing component.

In the fixing component, the carrier has a cover for covering the fixing component.

The fixing component further comprises an operating element, and the joining element has an insertion portion. The insertion portion of the joining element is fitted to the operating element or the engaging-connecting element.

In the fixing component, the engaging-connecting element or the operating element has a riveting portion. The riveting portion is riveted to the joining element.

In the fixing component, the joining element has a corresponding guiding portion corresponding in position to the operating element or the engaging-connecting element. The operating element or the engaging-connecting element has a guiding portion. The corresponding guiding portion guides the guiding portion, so as to guide the operating element or the engaging-connecting element to fit to the joining element.

The fixing component further comprises a fixing element, wherein the corresponding element, the engaging-connecting element or the joining element is movably fitted to the fixing element.

In the fixing component, the insertion portion of the joining element is a raised portion and is inserted into the engaging-connecting element.

In the fixing component, the joining element has a guiding portion, and the engaging-connecting element has a corresponding guiding portion for use in alignment, guidance and fitting.

In the fixing component, the engaging-connecting element is formed by fitting the body portion and engaging portion together.

In the fixing component, the joining element or the engaging portion has a riveting portion riveted to the engaging-connecting element or the body portion.

In the fixing component, the fixing element is movably fitted to the corresponding element, the engaging-connecting element, the engaging portion or the body portion.

In the fixing component, the engaging-connecting element is formed by fitting the body portion and engaging portion together, whereas the body portion has a corresponding guiding portion, and the engaging portion has a guiding portion for use in guidance and fitting.

The present disclosure further provides a fitting method for a fixing component to fit the fixing component. The fitting method involves fitting the joining element to the corresponding element, pressing and fitting the fitting portion of the engaging-connecting element to the insertion portion of the joining element, or integrally forming the joining element and the engaging-connecting element, fitting the joining element and the engaging-connecting element to the corresponding element while or then movably engaging-connecting the first inner engaging portion of the corresponding element to the outer engaging portion of the fixing element or movably fitting the engaging-connecting element to the second inner engaging portion of the fixing element.

The present disclosure further provides a fitting method for a fixing component to fit the fixing component. The fitting method involves fitting or integrally forming the joining element, the corresponding element and the engaging-connecting element, or integrally forming the joining element and the engaging-connecting element, such that the joining element and the engaging-connecting element are fitted to the corresponding element. The fixing element and an object are riveted, engaging-connected, expanded, screwed, welded or adhered to each other to form a module. Then, the first inner engaging portion of the corresponding element is movably engagingly-connected to the outer engaging portion of the fixing element, or the engaging-connecting element is movably fitted to the second inner engaging portion of the fixing element.

In the fitting method for the fixing component, the first inner engaging portion of the corresponding element is a resilient plastic element, when the first inner engaging portion of the corresponding element is movably engagingly-connected to the outer engaging portion of the fixing element, the first inner engaging portion expands or stretches to become larger than or as large as the outer engaging portion, and, the first inner engaging portion bounces and movably engagingly-connects with the outer engaging portion of the fixing element after the first inner engaging portion has passed the outer engaging portion.

In the fitting method for the fixing component, an auxiliary fitting tool operates in conjunction with the engaging-connecting portion of the engaging-connecting element, such that the first inner engaging portion is movably engagingly-connected to the outer engaging portion, or the fixing element is movably fitted to the engaging-connecting element.

In the fitting method for the fixing component, the auxiliary fitting tool has an inner thread, outer thread, through hole, raised portion or dented portion.

Therefore, the present disclosure provides the fastener structure of a fixing component and the fixing component which is manufactured from a simple structure and by a simple fitting method.

### BRIEF DESCRIPTION OF THE DRAWINGS

FIG. 1 is a schematic view of a fastener structure according to a preferred embodiment of the present disclosure.

FIG. 2 is a schematic view of a fixing component according to a preferred embodiment of the present disclosure.

FIG. 3 is a schematic view 1 of a corresponding element and a fixing element fitted together according to a preferred embodiment of the present disclosure.

FIG. 4 is a schematic view 2 of the corresponding element and the fixing element fitted together according to a preferred embodiment of the present disclosure.

FIG. 5 is a schematic view 3 of the corresponding element and the fixing element fitted together according to a preferred embodiment of the present disclosure.

FIG. 6 is a schematic view of a first engagement depression of the corresponding element and a second engagement depression of the fixing element according to a preferred embodiment of the present disclosure.

FIG. 7 is a schematic view of an engaging members of the corresponding element according to a preferred embodiment of the present disclosure.

FIG. 8 is a schematic view 1 of an outer peripheral surface of the corresponding element according to a preferred embodiment of the present disclosure.

FIG. 9 is a schematic view 2 of the outer peripheral surface of the corresponding element according to a preferred embodiment of the present disclosure.

FIG. 10 is a schematic view of an upper raised portion of a joining element according to a preferred embodiment of the present disclosure.

FIG. 11 is a schematic view of a lower raised portion of the joining element according to a preferred embodiment of the present disclosure.

FIG. 12 is a schematic view of an upper dented portion of the joining element according to a preferred embodiment of the present disclosure.

FIG. 13 is a schematic view of a lower dented portion of the joining element according to a preferred embodiment of the present disclosure.

FIG. 14 is a schematic view 1 of an outer peripheral surface of the joining element according to a preferred embodiment of the present disclosure.

FIG. 15 is a schematic view 2 of the outer peripheral surface of the joining element according to a preferred embodiment of the present disclosure.

FIG. 16 is a schematic view 3 of the outer peripheral surface of the joining element according to a preferred embodiment of the present disclosure.

FIG. 17 is a schematic view 4 of the outer peripheral surface of the joining element according to a preferred embodiment of the present disclosure.

FIG. 18 is a schematic view 5 of the outer peripheral surface of the joining element according to a preferred embodiment of the present disclosure.

FIG. 19 is a schematic view 6 of the outer peripheral surface of the joining element according to a preferred embodiment of the present disclosure.

FIG. 20 is a schematic view 7 of the outer peripheral surface of the joining element according to a preferred embodiment of the present disclosure.

FIG. 21 is a schematic view 8 of the outer peripheral surface of the joining element according to a preferred embodiment of the present disclosure.

FIG. 22 is a schematic view 9 of the outer peripheral surface of the joining element according to a preferred embodiment of the present disclosure.

FIG. 23 is a schematic view 10 of the outer peripheral surface of the joining element according to a preferred embodiment of the present disclosure.

FIG. 24 is a schematic view 1 of the joining element, the corresponding element and the engaging-connecting element fitted together according to a preferred embodiment of the present disclosure.

FIG. 25 is a schematic view 2 of the joining element, the corresponding element and the engaging-connecting element fitted together according to a preferred embodiment of the present disclosure.

FIG. 26 is a schematic view 1 of a die according to a preferred embodiment of the present disclosure.

FIG. 27 is a schematic view 1 of the engaging-connecting portion of the engaging-connecting element according to a preferred embodiment of the present disclosure.

FIG. 28 is a schematic view 2 of the engaging-connecting portion of the engaging-connecting element according to a preferred embodiment of the present disclosure.

FIG. 29 is a schematic view 3 of the engaging-connecting portion of the engaging-connecting element according to a preferred embodiment of the present disclosure.

FIG. 30 is a schematic view 1 of the joining element, corresponding element, engaging-connecting element, fixing element and resilient element fitted together according to a preferred embodiment of the present disclosure.

FIG. 31 is a schematic view 2 of the joining element, corresponding element, engaging-connecting element, fixing element and resilient element fitted together according to a preferred embodiment of the present disclosure.

FIG. 32 is a schematic view of a carrier and a cover of an auxiliary fetching body according to a preferred embodiment of the present disclosure.

FIG. 33 is a schematic view 1 of a head portion which is higher than the top surface of the corresponding element according to a preferred embodiment of the present disclosure.

FIG. 34 is a schematic view 2 of the head portion which is higher than the top surface of the corresponding element according to a preferred embodiment of the present disclosure.

FIG. 35 is a schematic view of the head portion which is flush with the top surface of the corresponding element according to a preferred embodiment of the present disclosure.

FIG. 36 is a schematic view of the head portion which is lower than the top surface of the corresponding element according to a preferred embodiment of the present disclosure.

FIG. 37 is a schematic view of the periphery of the head portion according to a preferred embodiment of the present disclosure.

FIG. 38 is a schematic view 2 of the die according to a preferred embodiment of the present disclosure.

FIG. 39 is a schematic view of the engaging-connecting element and the joining element integrally formed according to a preferred embodiment of the present disclosure.

FIG. 40 is a schematic view 3 of the die according to a preferred embodiment of the present disclosure.

FIG. 41 is a schematic view of the engaging-connecting element, the joining element and the corresponding element integrally formed according to a preferred embodiment of the present disclosure.

FIG. 42 is a schematic view 1 of operation of the fixing component according to a preferred embodiment of the present disclosure.

FIG. 43 is a schematic view 2 of operation of the fixing component according to a preferred embodiment of the present disclosure.

FIG. 44 is a schematic view 1 of a fitting method for a fixing component according to a preferred embodiment of the present disclosure.

FIG. 45 is a schematic view 2 of the fitting method for the fixing component according to a preferred embodiment of the present disclosure.

FIG. 46 is a schematic view 3 of the fitting method for the fixing component according to a preferred embodiment of the present disclosure.

FIG. 47 is a schematic view 4 of the fitting method for the fixing component according to a preferred embodiment of the present disclosure.

FIG. 48 is a schematic view 1 of another fitting method for the fixing component according to a preferred embodiment of the present disclosure.

FIG. 49 is a schematic view 2 of another fitting method for the fixing component according to a preferred embodiment of the present disclosure.

FIG. 50 is a schematic view 1 of yet another fitting method for the fixing component according to a preferred embodiment of the present disclosure.

FIG. 51 is a schematic view 2 of yet another fitting method for the fixing component according to a preferred embodiment of the present disclosure.

FIG. 52 is a schematic view of an auxiliary fitting tool according to a preferred embodiment of the present disclosure.

FIG. 53 is a schematic view 1 of another aspect of a preferred embodiment of the present disclosure.

FIG. 54 is an exploded view based on FIG. 53 according to the present disclosure.

FIG. 55 is a schematic view 2 of another aspect of a preferred embodiment of the present disclosure.

FIG. 56 is a schematic view 3 of another aspect of a preferred embodiment of the present disclosure.

FIG. 57 is a schematic view 4 of another aspect of a preferred embodiment of the present disclosure.

FIG. 58 is a schematic view 5 of another aspect of a preferred embodiment of the present disclosure.

FIG. 59 is an exploded view based on FIG. 58 according to the present disclosure.

FIG. 60 is a schematic view 6 of another aspect of a preferred embodiment of the present disclosure.

FIG. 61 is a schematic view 7 of another aspect of a preferred embodiment of the present disclosure.

FIG. 62 is a schematic view 8 of another aspect of a preferred embodiment of the present disclosure.

FIG. 63 is a schematic view 3 of the die according to a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

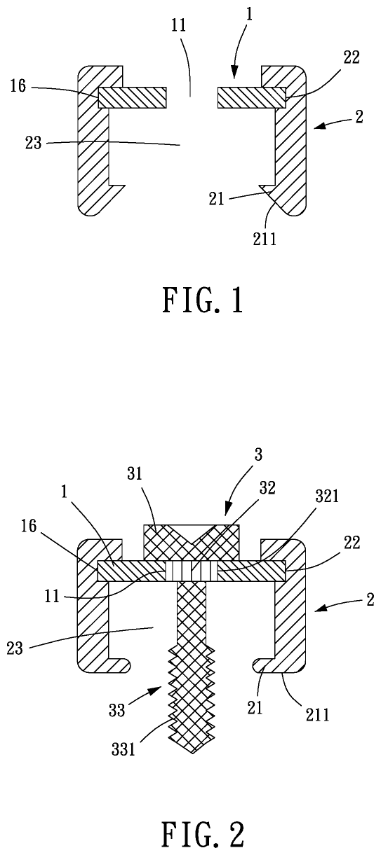

Referring to FIG. 1 and FIG. 2, the first aspect of the present disclosure provides a fastener structure of a fixing component, which comprises a joining element 1 and a corresponding element 2. The joining element 1 is fitted to the corresponding element 2. The joining element 1 is for use in fitting an engaging-connecting element 3 in place. Therefore, the fastener structure of the fixing component can be manufactured from a simple structure.

Referring to FIG. 1, in the fastener structure of the fixing component, the corresponding element 2 is a cylinder, or the joining element 1 and the corresponding element 2 combine to become a cylinder. The cylinder has a receiving space 23. The joining element 1 is panel-shaped. The outer peripheral surface of the joining element 1 operates in conjunction with a joining portion 22 of the corresponding element 2. The joining portion 22 is bump-shaped, dent-shaped, depression-shaped, dentate, polygonal, or stepped. When it is polygonal, the joining portion 22 has sides which are in an odd number or in an even number.

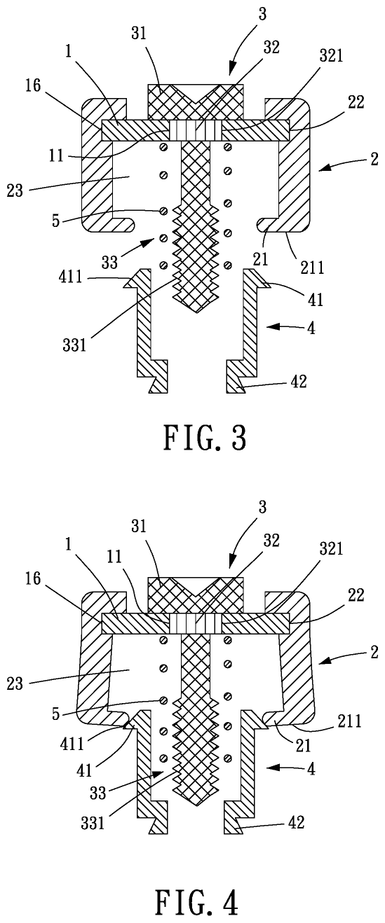

Referring to FIG. 1 through FIG. 5, in the fastener structure of the fixing component, a first inner engaging portion 21 is disposed at the bottom of the corresponding element 2. The first inner engaging portion 21 is for movably engaging-connecting with a fixing element 4. The fixing element 4 is movable inside and outside the receiving space 23. The first inner engaging portion 21 is a flange which extends toward the inside of the corresponding element 2. The fixing element 4 is a cylinder.

Referring to FIG. 1 through FIG. 4, in the fastener structure of the fixing component, a first pressing surface 211 is disposed at the bottom of the first inner engaging portion 21 and is an oblique surface (or flat surface or curved surface or arcuate surface) for pressing against the fixing element 4 when the corresponding element 2 is fitted to the fixing element 4.

Referring to FIG. 1 through FIG. 5, in the fastener structure of the fixing component, the first inner engaging portion 21 is a resilient plastic element whereby the corresponding element 2 undergoes resilient deformation when the corresponding element 2 is fitted to the fixing element 4.

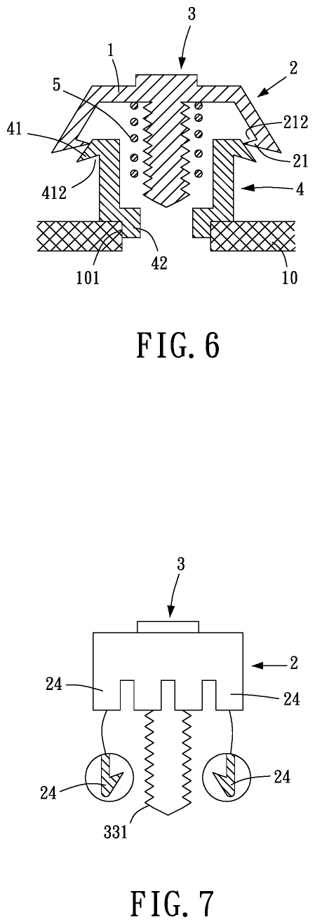

Referring to FIG. 6, in the fastener structure of the fixing component, the first inner engaging portion 21 has a first engagement depression 212 for firmly, movably engaging-connecting with the fixing element 4.

Referring to FIG. 7, in the fastener structure of the fixing component, the corresponding element 2 has a plurality of engaging members 24 for movably engaging-connecting with the fixing element 4.

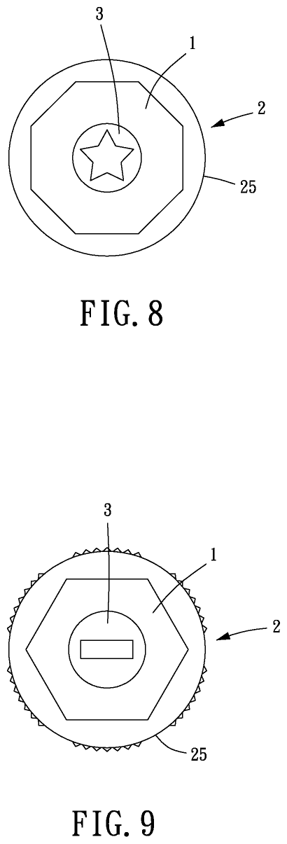

Referring to FIG. 8 and FIG. 9, in the fastener structure of the fixing component, the outer peripheral surface 25 of the corresponding element 2 is a smooth surface (shown in FIG. 8) or has a gear rack (shown in FIG. 9) (or teeth or three-dimensional pattern), so as to facilitate a user's grip.

Referring to FIG. 1 and FIG. 2, in the fastener structure of the fixing component, the joining element 1 has an insertion portion 11, and the insertion portion 11 insertedly fixes the engaging-connecting element 3 in place. The insertion portion 11 is a through hole with a slightly smaller diameter than the fitting portion 32 of the engaging-connecting element 3.

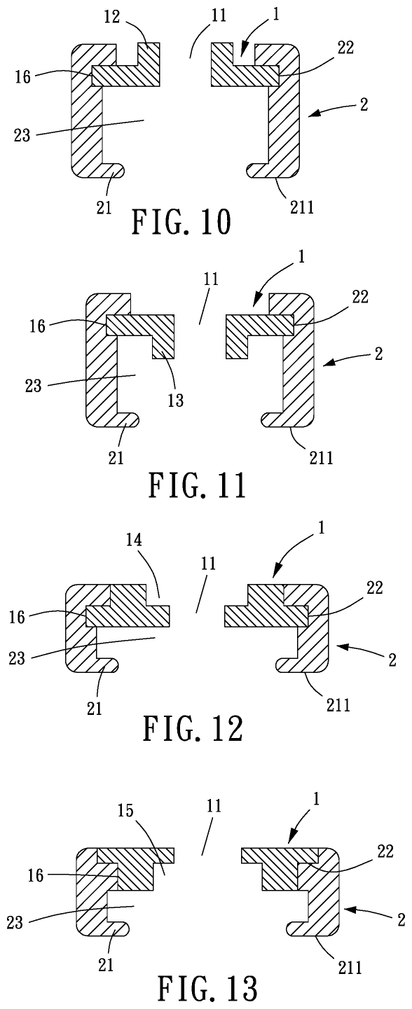

Referring to FIG. 10 through FIG. 13, in the fastener structure of the fixing component, the insertion portion 11 of the joining element 1 has an upper raised portion 12, lower raised portion 13, upper dented portion 14 or lower dented portion 15 whereby the joining element 1 is fixed to the engaging-connecting element 3.

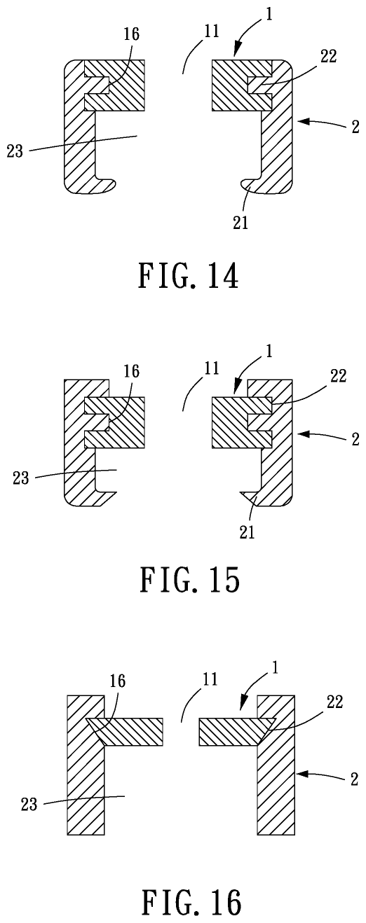

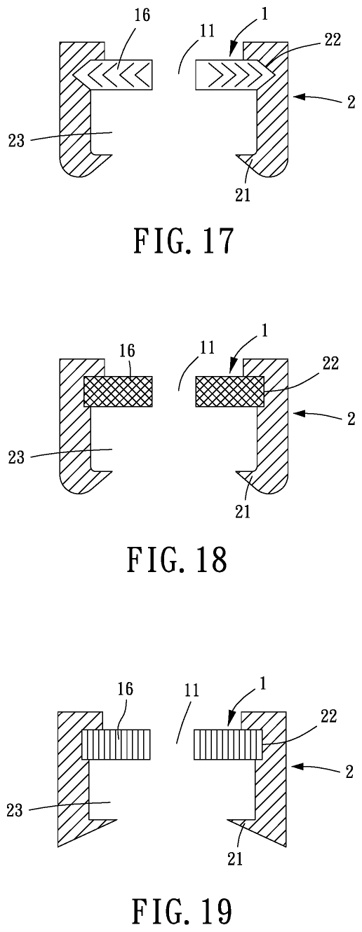

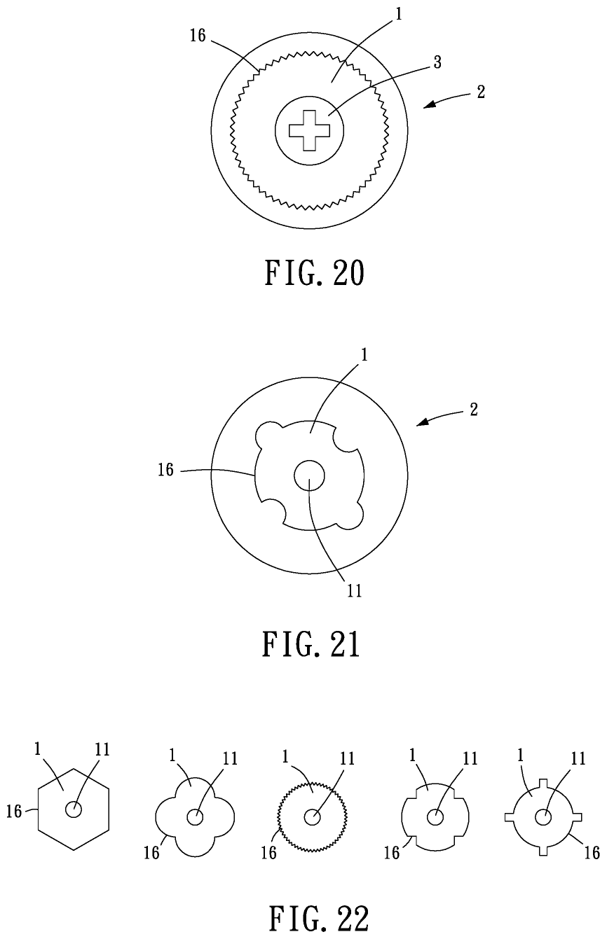

Referring to FIG. 14 through FIG. 25, in the fastener structure of the fixing component, an outer peripheral surface 16 of the joining element 1 has a three-dimensional pattern, teeth, gear rack, dented portion, raised portion, flat surface, oblique surface, curved surface or arcuate surface whereby the joining element 1 is fitted to the corresponding element 2.

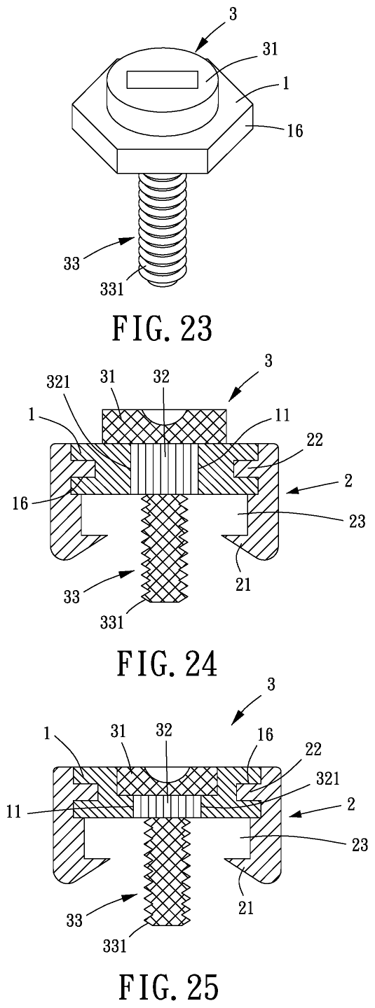

Referring to FIG. 23, in the fastener structure of the fixing component, the outer peripheral surface 16 of the joining element 1 has an even number of sides (or an odd number of sides or is circular) whereby the joining element 1 is fitted to the corresponding element 2.

Referring to FIG. 14 and FIG. 15, FIG. 24 and FIG. 25, in the fastener structure of the fixing component, a lower portion and a lateral portion at edges of the joining element 1 are fitted to the corresponding element 2, or an upper portion, the lower portion and the lateral portion at edges of the joining element 1 are fitted to the corresponding element 2. Alternatively, the upper portion at an edge of the joining element 1 is fitted to the corresponding element 2. Alternatively, the lower portion at an edge of the joining element 1 is fitted to the corresponding element 2. Alternatively, the lateral portion at an edge of the joining element 1 is fitted to the corresponding element 2. Alternatively, the upper portion and the lower portion at edges of the joining element 1 are fitted to the corresponding element 2. Alternatively, the upper portion and the lateral portion at edges of the joining element 1 are fitted to the corresponding element 2.

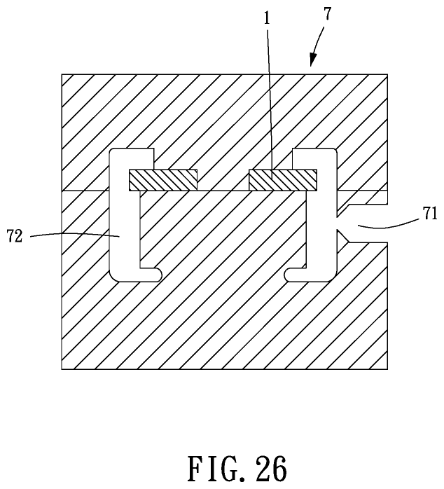

Referring to FIG. 26, in the fastener structure of the fixing component, the corresponding element 2 is fitted to the joining element 1 by plastic insert molding. The fastener structure of the fixing component further comprises a die 7. The die 7 has a feed port 71 and a corresponding element receiving space 72 which are in communication with each other. The joining element 1 is disposed in the die 7 and connected to the corresponding element receiving space 72. A plastic liquid is introduced into the feed port 71 and the corresponding element receiving space 72 so as for the corresponding element 2 to be fitted to the joining element 1. The die 7 is pressed between the joining element 1, the insertion portion 11 of the joining element 1, and the corresponding element 2 to stop the plastic liquid introduced into the corresponding element receiving space 72 from overflowing, flowing into or entering the insertion portion 11 or the vicinity of the insertion portion 11.

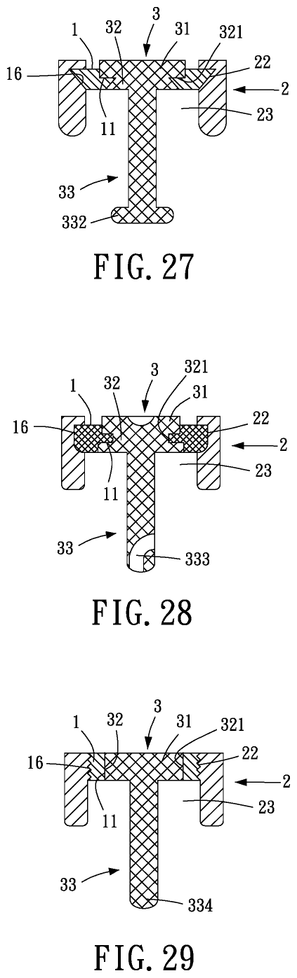

Referring to FIG. 27 through FIG. 29, regarding the fastener structure of the fixing component, the corresponding element 2 is fitted to the joining element 1 by hot fusion, riveting, expansion, adhesion, screwing or welding.

In the fastener structure of the fixing component, the joining element 1 is made of plastic or metal, and the corresponding element 2 is made of plastic or metal.

Referring to FIG. 32, the fastener structure of the fixing component further comprises a carrier 8 with a receiving chamber 81 for receiving the fastener structure. The carrier 8 is a tray or a band.

Referring to FIG. 32, the fastener structure of the fixing component further comprises an auxiliary fetching body 6 disposed on the fastener structure, such that a fetching device can fetch the fastener structure through the auxiliary fetching body 6. The auxiliary fetching body 6 has magnetism or adhesiveness or is a fastener.

Referring to FIG. 32, in the fastener structure of the fixing component, the carrier 8 has a cover 9 for covering the fastener structure to prevent the fastener structure from falling or being contaminated.

Referring to FIG. 2, the second aspect of the present disclosure provides a fixing component which comprises an engaging-connecting element 3 and the aforesaid fastener structure. The engaging-connecting element 3 has a head portion 31, a fitting portion 32 and an engaging-connecting portion 33 which are sequentially connected, with the fitting portion 32 fitted to the joining element 1. Therefore, the fixing component can be manufactured from a simple structure.

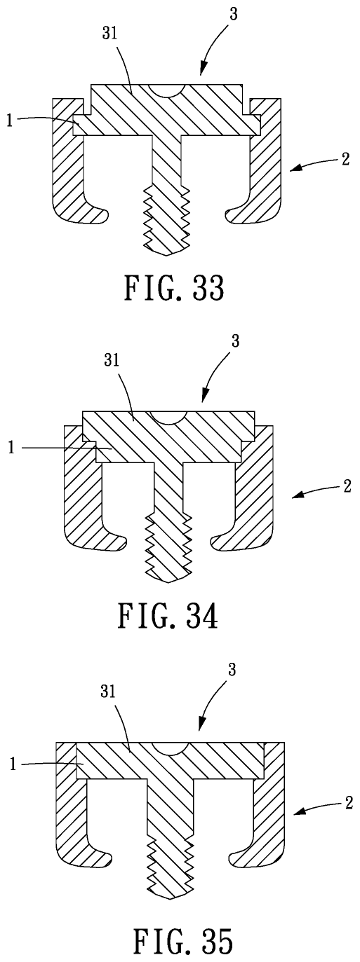

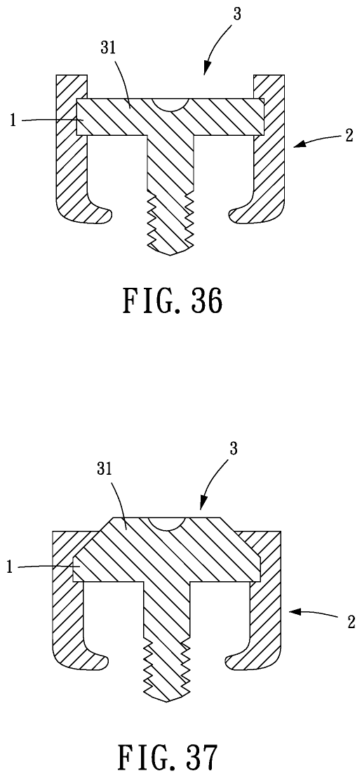

Referring to FIG. 33 through FIG. 36, in the fixing component, the head portion 31 of the engaging-connecting element 3 is higher than, flush with or lower than the top surface of the corresponding element 2.

Referring to FIG. 37, in the fixing component, the periphery of the head portion 31 of the engaging-connecting element 3 is an oblique surface (or arcuate surface or curved surface).

Referring to FIG. 2, FIG. 27 through FIG. 31, regarding the fixing component, an outer peripheral surface 321 of the fitting portion 32 of the engaging-connecting element 3 has three-dimensional pattern, teeth, gear rack, dented portion, raised portion, flat surface, oblique surface, curved surface or arcuate surface and thus is fitted to the joining element 1 by riveting, engaging-connecting, expansion, screwing, welding, adhesion or hot fusion.

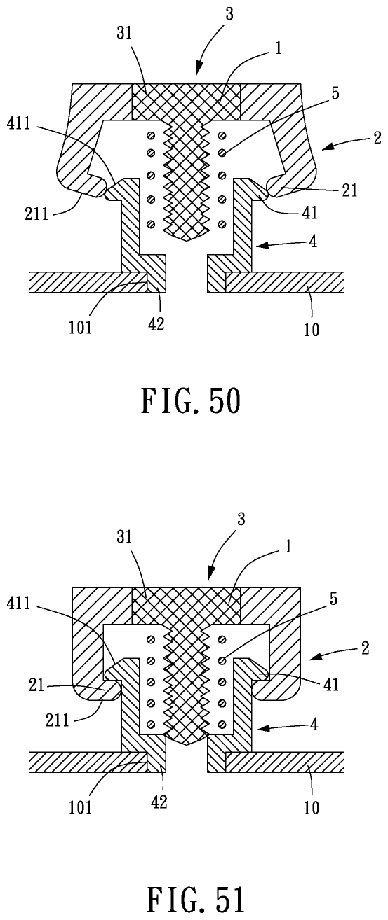

Referring to FIG. 23, FIG. 33 through FIG. 39, FIG. 50 through FIG. 51, in the fixing component, the engaging-connecting element 3 is integrally formed with the joining element 1 by lathing, forging, stamping, plastic injection or metal injection.

Referring to FIG. 2, FIG. 27 through FIG. 29, in the fixing component, the fitting portion 32 of the engaging-connecting element 3 is an outer thread (or inner thread), external fastener, internal fastener or post.

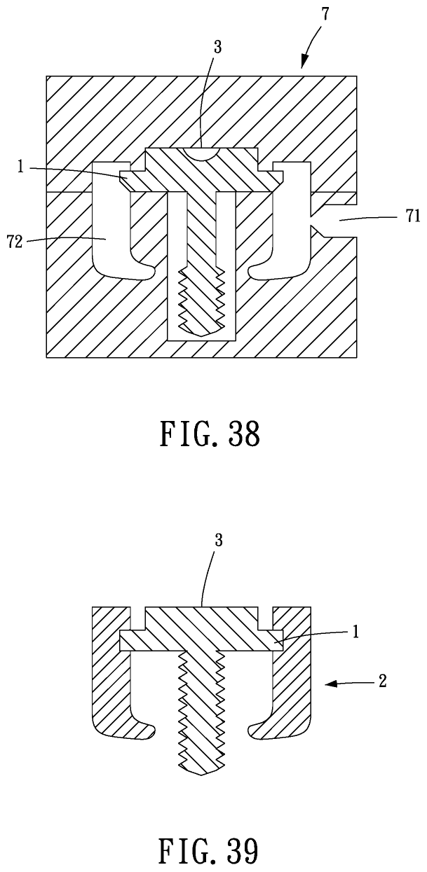

Referring to FIG. 38 and FIG. 39, in the fixing component, the joining element 1 and the engaging-connecting element 3 are integrally formed, and the corresponding element 2 is fitted to the joining element 1 by plastic insert molding. The fixing component further comprises a die 7. The die 7 has a feed port 71 and a corresponding element receiving space 72 which are in communication with each other. The joining element 1 and the engaging-connecting element 3 are integrally formed, and the integrally formed structure is disposed in the die 7. The joining element 1 is connected to the corresponding element receiving space 72. The plastic liquid is introduced into the feed port 71 and the corresponding element receiving space 72 so as for the corresponding element 2 to be fitted to the joining element 1. The die 7 is pressed between the joining element 1, the head portion 31, and the corresponding element 2 to stop the plastic liquid introduced into the corresponding element receiving space 72 from overflowing, flowing into or entering the head portion 31 or the vicinity of the head portion 31.

Furthermore, the joining element 1 and the engaging-connecting element 3 are integrally formed, or the joining element 1 and the engaging-connecting element 3 are fitted together.

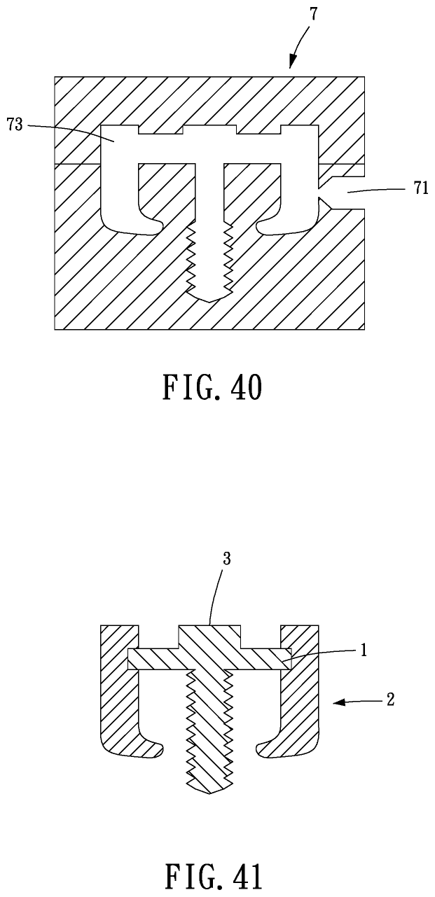

Referring to FIG. 40 and FIG. 41, in the fixing component, the engaging-connecting element 3, the joining element 1 and the corresponding element 2 are integrally formed by lathing, forging, stamping, plastic injection or metal injection. The fixing component further comprises a die 7. The die 7 has a feed port 71 and a fixing component receiving space 73 which are in communication with each other. A plastic liquid is introduced into the feed port 71 and the fixing component receiving space 73 to form the fixing component. Furthermore, the joining element 1, the corresponding element 2 and the engaging-connecting element 3 are fitted together to form a module.

Referring to FIG. 32, the fixing component further comprises a carrier 8 with a receiving chamber 81 for receiving the fixing component. The carrier 8 is a tray or a band.

Referring to FIG. 32, the fixing component further comprises an auxiliary fetching body 6 disposed on the fixing component, such that the fetching device can fetch the fixing component through the auxiliary fetching body 6. The auxiliary fetching body 6 has magnetism or adhesiveness or is a fastener.

Referring to FIG. 32, in the fixing component, the carrier 8 has a cover 9 for covering the fixing component to prevent the fixing component from falling or being contaminated.

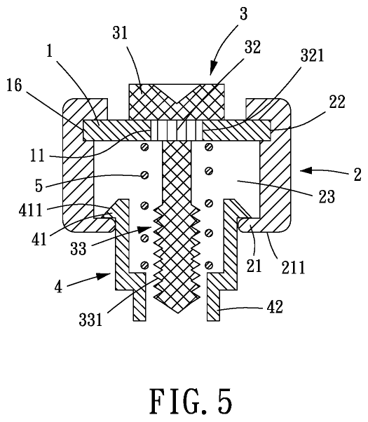

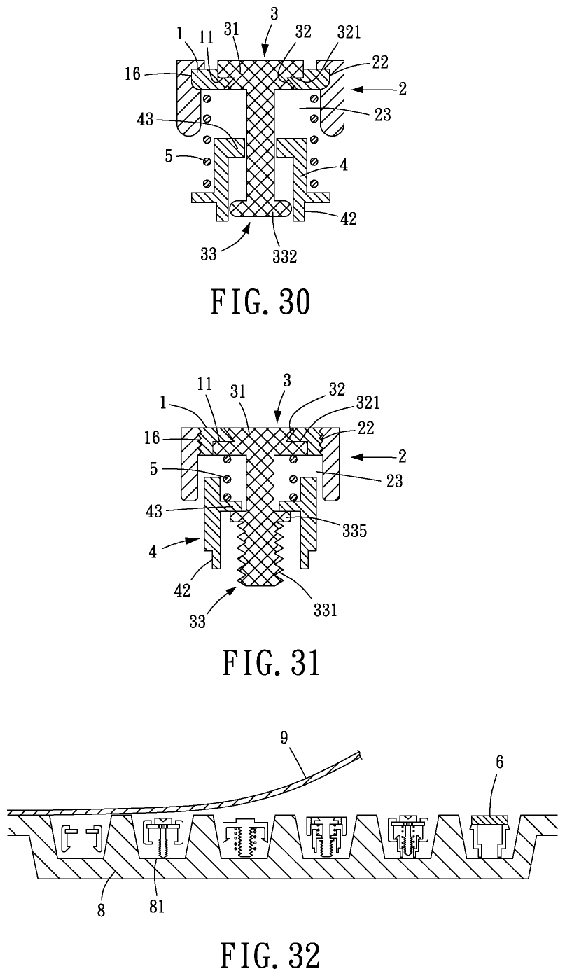

Referring to FIG. 5, FIG. 30 and FIG. 31, the fixing component further comprises a fixing element 4. The fixing element 4 is movably fitted to the engaging-connecting element 3 or the corresponding element 2.

Referring to FIG. 5, in the fixing component, the fixing element 4 has an outer engaging portion 41 movably engaging-connecting with the first inner engaging portion 21 of the corresponding element 2. The outer engaging portion 41 is a flange extending away from the fixing element 4.

Referring to FIG. 6, in the fixing component, the outer engaging portion 41 of the fixing element 4 has a second engagement depression 412 whereby the outer engaging portion 41 is firmly movably engaging-connecting with the first inner engaging portion 21 of the corresponding element 2.

Referring to FIG. 5, in the fixing component, the top portion of the outer engaging portion 41 of the fixing element 4 has a second pressing surface 411, and the second pressing surface 411 is an oblique surface (or flat surface or curved surface or arcuate surface). Hence, when the fixing element 4 is fitted to the corresponding element 2, it presses against the first pressing surface 211 of the first inner engaging portion 21 of the corresponding element 2 outward.

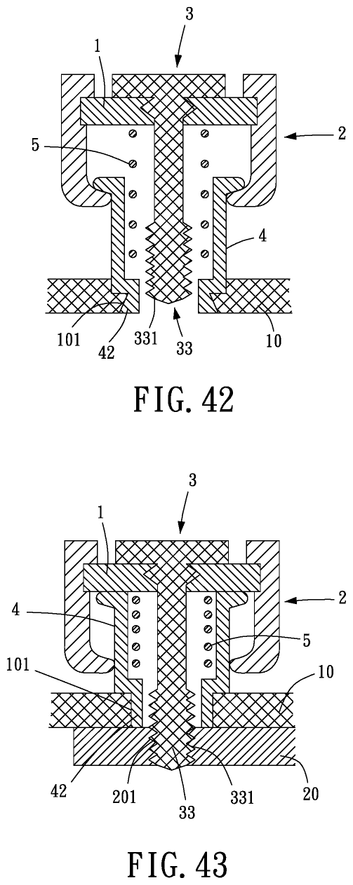

Referring to FIG. 5, FIG. 30 and FIG. 31, FIG. 42 and FIG. 43, in the fixing component, the fixing element 4 has a fixing portion 42 for being riveted, engagingly-connected, expanded, screwed, welded or adhered to an object 10.

In the fixing component, the joining element 1, the corresponding element 2, the fixing element 4 and the engaging-connecting element 3 can be fitted together to become a module. Furthermore, the joining element 1, the corresponding element 2, the fixing element 4, the engaging-connecting element 3 and the object 10 can also be fitted together to become a module. The object 10 is fitted to the fixing element 4.

Referring to FIG. 30 and FIG. 31, in the fixing component, the fixing element 4 has a second inner engaging portion 43 whereby the fixing element 4 is movably fitted to the engaging-connecting element 3. The second inner engaging portion 43 is a flange extending toward the inside of the fixing element 4. The second inner engaging portion 43 is movably engagingly-connected to the engaging-connecting portion 33 of the engaging-connecting element 3 or movably engagingly-connected to the engagement flange 335 of the engaging-connecting element 3. The engagement flange 335 is above the engaging-connecting portion 33.

Referring to FIG. 32, the fixing component further comprises a carrier 8 with a receiving chamber 81 for receiving the fixing component. The carrier 8 is a tray or a band.

Referring to FIG. 32, the fixing component further comprises an auxiliary fetching body 6 disposed on the fixing component, such that the fetching device can fetch the fixing component through the auxiliary fetching body 6. The auxiliary fetching body 6 has magnetism or adhesiveness or is a fastener.

Referring to FIG. 32, in the fixing component, the carrier 8 has a cover 9 for covering the fixing component to prevent the fixing component from falling or being contaminated.

Referring to FIG. 5, FIG. 42 and FIG. 43, the fixing component further comprises a resilient element 5 with one end pressing against the joining element 1 or the corresponding element 2 and another end pressing against the fixing element 4. Therefore, the fixing element 4 can extend and retract relative to the joining element 1, the corresponding element 2 and the engaging-connecting element 3.

In the fixing component, the joining element 1, the corresponding element 2, the fixing element 4, the engaging-connecting element 3 and the resilient element 5 are fitted together to form a module. Furthermore, the joining element 1, the corresponding element 2, the fixing element 4, the engaging-connecting element 3, the resilient element 5 and the object 10 are fitted together to form a module. The object 10 is fitted to the fixing element 4.

Referring to FIG. 42 and FIG. 43, to operate the fixing component of the present disclosure, the fixing portion 42 of the fixing element 4 is fitted to a first fixing hole 101 of the object 10, and then the engaging-connecting element 3 is pressed downward or rotated, such that the engaging-connecting portion 33 of the engaging-connecting element 3 is fitted to a second fixing hole 201 of another object 20, thereby fitting together the two objects 10, 20.

Referring to FIG. 32, the fixing component further comprises a carrier 8 with a receiving chamber 81 for receiving the fixing component. The carrier 8 is a tray or a band.

Referring to FIG. 32, the fixing component further comprises an auxiliary fetching body 6 disposed on the fixing component, such that the fetching device can fetch the fixing component through the auxiliary fetching body 6. The auxiliary fetching body 6 has magnetism or adhesiveness or is a fastener.

Referring to FIG. 32, in the fixing component, the carrier 8 has a cover 9 for covering the fixing component to prevent the fixing component from falling or being contaminated.

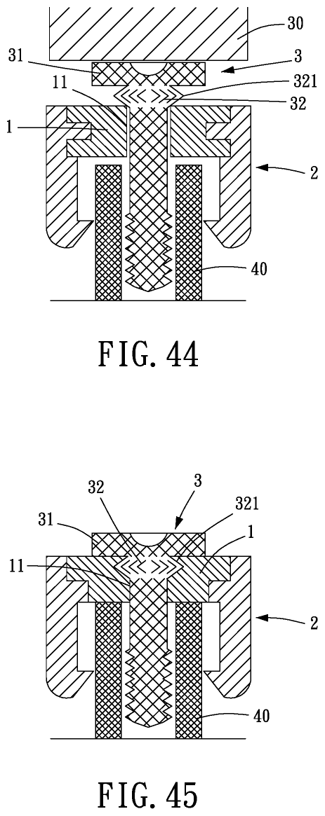

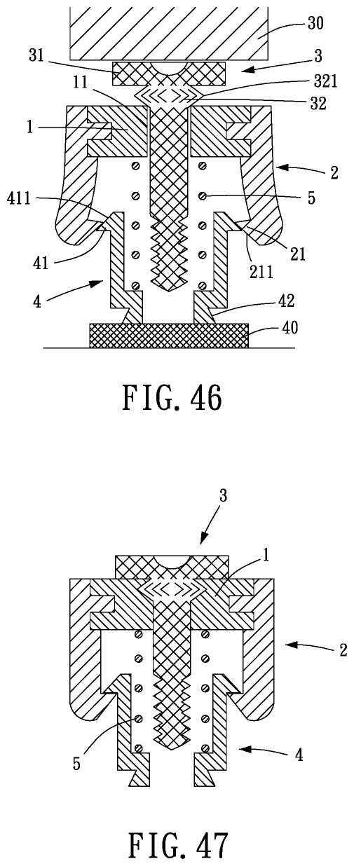

Referring to FIG. 44 through FIG. 47, the third aspect of the present disclosure provides a fitting method for a fixing component, for fitting the fixing component in place, The fitting method involves fitting the joining element 1 to the corresponding element 2, supporting the joining element 1 and the corresponding element 2 with a support element 40, and pressing the engaging-connecting element 3 with a pressing element 30, so as to pressingly fit the fitting portion 32 of the engaging-connecting element 3 into the insertion portion 11 of the joining element 1. Alternatively, the fitting method involves integrally forming the joining element 1 and the engaging-connecting element 3 such that the joining element 1 and the engaging-connecting element 3 fit to the corresponding element 2 mutually and then pressing the engaging-connecting element 3 with the pressing element 30 so as to press the first inner engaging portion 21 of the corresponding element 2 against the outer engaging portion 41 of the fixing element 4 and expand the first inner engaging portion 21 of the corresponding element 2, thereby allowing the first inner engaging portion 21 of the corresponding element 2 to be movably engagingly-connected to the outer engaging portion 41 of the fixing element 4 from outside (or allowing the engaging-connecting element 3 to be movably fitted to the second inner engaging portion 43 of the fixing element 4.) Furthermore, the joining element 1 and the corresponding element 2 are integrally formed. Therefore, the fixing component can be manufactured by a simple fitting method.

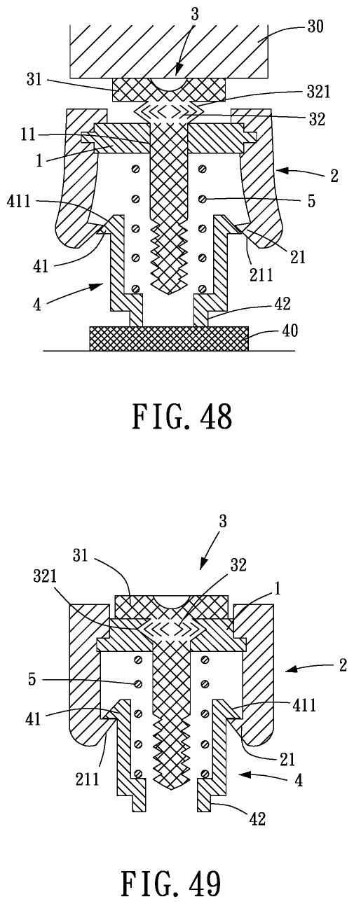

Referring to FIG. 48 and FIG. 49, the fitting method for the fixing component in the third aspect involves fitting the joining element 1 to the corresponding element 2, pressing the engaging-connecting element 3 with the pressing element 30, pressing the fitting portion 32 of the engaging-connecting element 3 into the insertion portion 11 of the joining element 1, pressing the first inner engaging portion 21 of the corresponding element 2 against the outer engaging portion 41 of the fixing element 4, fitting the fitting portion 32 of the engaging-connecting element 3 to the insertion portion 11 of the joining element 1, expanding the first inner engaging portion 21 of the corresponding element 2, thereby allowing the first inner engaging portion 21 of the corresponding element 2 to be movably engagingly-connected to the outer engaging portion 41 of the fixing element 4 from outside (or allowing the engaging-connecting element 3 to be movably fitted to the second inner engaging portion 43 of the fixing element 4). Furthermore, the joining element 1 and the corresponding element 2 are integrally formed. Therefore, the fixing component can be manufactured by a simple fitting method.

Referring to FIG. 50 and FIG. 51, the fourth aspect of the present disclosure provides a fitting method for a fixing component, for fitting the fixing component. The fitting method involves fitting together or integrally forming the joining element 1, the corresponding element 2 and the engaging-connecting element 3 (or integrally forming the joining element 1 and the engaging-connecting element 3 and then fitting them and the corresponding element 2 together), riveting, engaging-connecting, expanding, screwing, welding or adhering the fixing element 4 and the object 10 to each other to form a module, pressing the engaging-connecting element 3 with the pressing element 30, pressing the first inner engaging portion 21 of the corresponding element 2 against the outer engaging portion 41 of the fixing element 4, expanding the first inner engaging portion 21 of the corresponding element 2, thereby allowing the first inner engaging portion 21 of the corresponding element 2 to be movably engagingly-connected to the outer engaging portion 41 of the fixing element 4 from outside (or allowing the engaging-connecting element 3 to be movably fitted to the second inner engaging portion 43 of the fixing element 4). Therefore, the fixing component can be manufactured by a simple fitting method.

Referring to FIG. 44 through FIG. 51, the third aspect and the fourth aspect provides a fitting method for a fixing component, wherein the first inner engaging portion 21 of the corresponding element 2 is a resilient plastic element. When the first inner engaging portion 21 of the corresponding element 2 is movably engagingly-connected to the outer engaging portion 41 of the fixing element 4, the first inner engaging portion 21 expands or stretches to become larger than or as large as the outer engaging portion 41. After the first inner engaging portion 21 has passed the outer engaging portion 41, the first inner engaging portion 21 bounces and movably engagingly-connects with the outer engaging portion 41 of the fixing element 4 from outside.

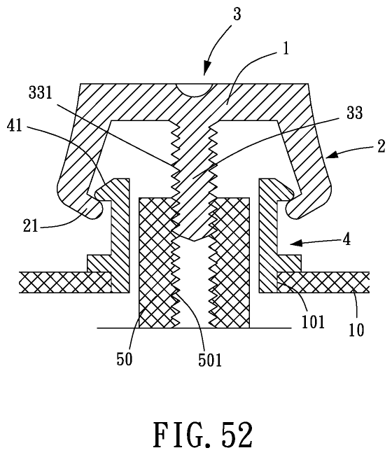

Referring to FIG. 52, regarding the fitting method for a fixing component in the fourth aspect, an auxiliary fitting tool 50 operates in conjunction with the engaging-connecting portion 33 of the engaging-connecting element 3, such that the first inner engaging portion 21 of the corresponding element 2 is movably engagingly-connected to the outer engaging portion 41 of the fixing element 4 from outside. (Alternatively, the fixing element 4 is movably fitted to the engaging-connecting element 3.)

Referring to FIG. 52, regarding the fitting method for a fixing component in the fourth aspect, the auxiliary fitting tool 50 has an inner thread 501 (or outer thread, through hole, raised portion or dented portion) which meshes with an outer thread 331 of the engaging-connecting portion 33 of the engaging-connecting element 3. For instance, when the outer thread 331 of the engaging-connecting element 3 meshes with the inner thread 501 of the auxiliary fitting tool 50, the first inner engaging portion 21 of the corresponding element 2 presses against the outer engaging portion 41 of the fixing element 4, such that the first inner engaging portion 21 of the corresponding element 2 expands and then movably engagingly-connects with the outer engaging portion 41 of the fixing element 4 from outside.

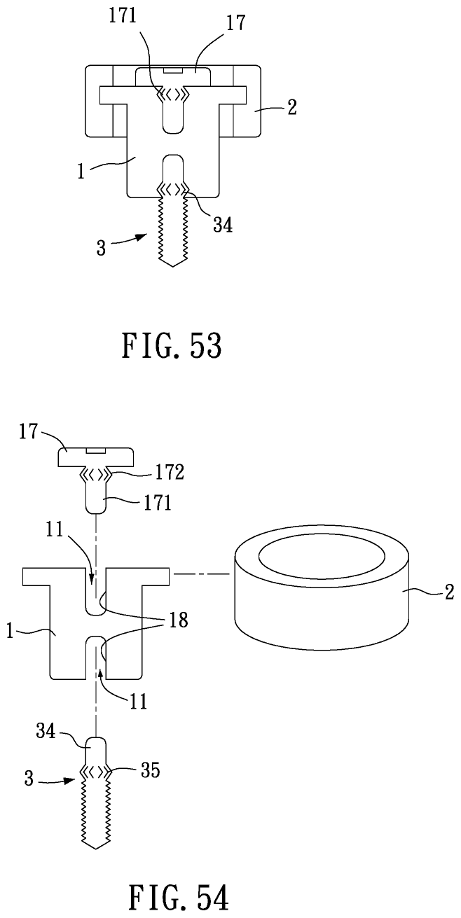

Referring to FIG. 53 and FIG. 54, the present disclosure further comprises an operating element 17, and the joining element 1 has an insertion portion 11. The insertion portion 11 of the joining element 1 is fitted to the operating element and the engaging-connecting element 3. The joining element 1 corresponds in position to the operating element 17; alternatively, the engaging-connecting element 3 has a corresponding guiding portion 18. The operating element 17 or the engaging-connecting element 3 has a guiding portion 171, 34. The corresponding guiding portion 18 guides the guiding portions 171, 34 and thereby guides the operating element 17 and the engaging-connecting element 3 fitting to the joining element 1. The engaging-connecting element 3 or the operating element 17 has a riveting portion 35, 172. The riveting portion 35, 172 is riveted to the joining element 1.

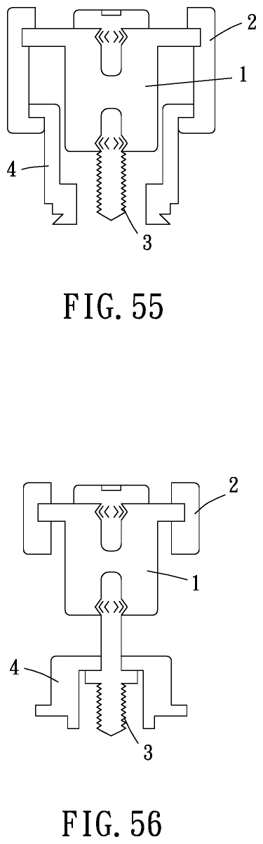

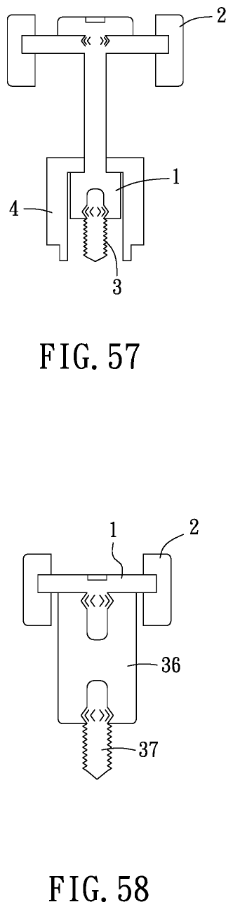

Referring to FIG. 55 through FIG. 57, the fastener structure further comprises a fixing element 4. The corresponding element 2, the engaging-connecting element 3 and the joining element 1 are movably fitted to the fixing element 4.

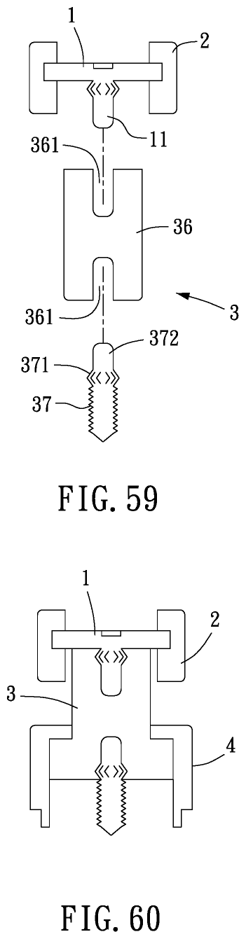

Referring to FIG. 58 and FIG. 59, the engaging-connecting element 3 is formed by fitting the body portion 36 and engaging portion 37 together. The insertion portion 11 of the joining element 1 is a raised portion and is inserted into the body portion 36 of the engaging-connecting element 3. The joining element 1 has a guiding portion (such as insertion portion 11). The engaging-connecting element 3 has a corresponding guiding portion 361 for use in alignment, guidance and fitting. The joining element 1 or the engaging portion 37 has a riveting portion 371 riveted to the body portion 36 of the engaging-connecting element 3. The body portion 36 has a corresponding guiding portion 361. The engaging portion 37 has a guiding portion 372 for use in guidance and fitting.

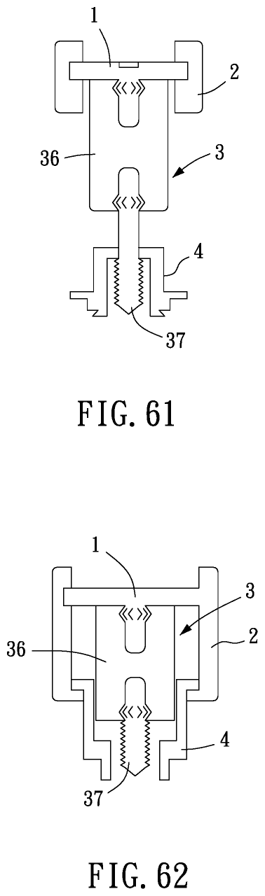

Referring to FIG. 60 through FIG. 62, the fixing element 4 is movably fitted to the corresponding element 2, the engaging-connecting element 3, the engaging portion 37 or the body portion 36.

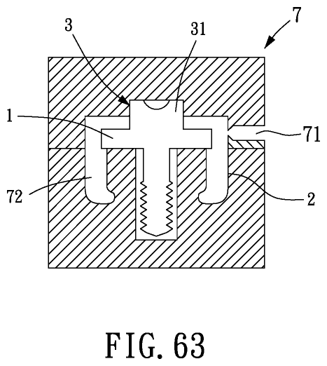

Referring to FIG. 63, the die 7 is pressed between the head portion 31 and the corresponding element 2 to stop the plastic liquid introduced into the corresponding element receiving space 72 from overflowing, flowing into or entering the head portion 31 or the vicinity of the head portion 31.

While the present disclosure has been described by means of specific embodiments, numerous modifications and variations could be made thereto by those skilled in the art without departing from the scope and spirit of the present disclosure set forth in the claims.

What is claimed is:

1. A fastener structure of a fixing component, comprising a joining element and a corresponding element, the joining element being fitted to the corresponding element and an engaging-connecting element.

2. The fastener structure of claim 1, further comprising a die, the die having a feed port and a corresponding element receiving space which are in communication with each other, the joining element being disposed in the die and connected to the corresponding element receiving space, wherein a plastic liquid is introduced into the feed port and the corresponding element receiving space so as for the corresponding element to be fitted to the joining element.

3. The fastener structure of claim 2, wherein the die is pressed between the joining elements, an insertion portion of the joining element, and the corresponding element to stop the plastic liquid introduced into the corresponding element receiving space from overflowing, flowing into or entering the insertion portion or vicinity of the insertion portion.

4. The fastener structure of claim 1, further comprising a fixing element movably fitted to the corresponding element, the engaging-connecting element or the joining element.

5. A fixing component, comprising an engaging-connecting element and the fastener structure of claim 1, the engaging-connecting element having a head portion, fitting portion and engaging-connecting portion which are sequentially connected, with the fitting portion fitted to the joining element.

6. The fastener structure of claim 2, wherein the die is pressed between the joining element, a head portion of the engaging-connecting element, the head portion of the engaging-connecting element, and the corresponding element to stop the plastic liquid introduced into the corresponding element receiving space from overflowing, flowing into or entering the head portion of the engaging-connecting element or vicinity of the head portion of the engaging-connecting element.

7. The fastener structure of claim 2, wherein the die is pressed between a head portion of the engaging-connecting element and the corresponding element to stop the plastic liquid introduced into the corresponding element receiving space from overflowing, flowing into or entering the head portion of the engaging-connecting element or vicinity of the head portion of the engaging-connecting element.

8. The fastener structure of claim 1, wherein the joining element and the engaging-connecting element are integrally formed, or the joining element and the engaging-connecting element are fitted together.

9. The fastener structure of claim 1, wherein the first inner engaging portion of the corresponding element is a resilient plastic element, when the first inner engaging portion of the corresponding element is movably engagingly-connected to the outer engaging portion of the fixing element, the first inner engaging portion expands or stretches to become larger than or as large as the outer engaging portion, and the first inner engaging portion bounces and movably engagingly-connects with the outer engaging portion of the fixing element after the first inner engaging portion has passed the outer engaging portion.

10. A fastener structure of a fixing component, comprising a joining element and a corresponding element, the joining element being fitted to the corresponding element and having an engaging-connecting portion.

11. The fastener structure of claim 10, further comprising a die, the die having a feed port and a corresponding element receiving space which are in communication with each other, the joining element being disposed in the die and connected to the corresponding element receiving space, wherein a plastic liquid is introduced into the feed port and the corresponding element receiving space so as for the corresponding element to be fitted to the joining element.

12. The fastener structure of claim 11, wherein the die is pressed between the joining element, a head portion of the joining element, or the head portion of the joining element, and the corresponding element to stop the plastic liquid introduced into the corresponding element receiving space from overflowing, flowing into or entering the head portion of the joining element or vicinity of the head portion of the joining element.

13. The fastener structure of claim 11, wherein the die is pressed between a head portion of the joining element and the corresponding element to stop the plastic liquid introduced into the corresponding element receiving space from overflowing, flowing into or entering the head portion of the joining element or vicinity of the head portion of the joining element.

14. The fastener structure of claim 10, wherein the first inner engaging portion of the corresponding element is a resilient plastic element, when the first inner engaging portion of the corresponding element is movably engagingly-connected to the outer engaging portion of the fixing element, the first inner engaging portion expands or stretches to become larger than or as large as the outer engaging portion, and the first inner engaging portion bounces and movably engagingly-connects with the outer engaging portion of the fixing element after the first inner engaging portion has passed the outer engaging portion.

15. The fastener structure of claim 10, further comprising a fixing element, wherein the corresponding element, the engaging-connecting portion or the joining element is movably fitted to the fixing element.

16. A fastener structure of a fixing component, comprising a joining element and a corresponding element, the joining element being fitted to the corresponding element.

17. The fastener structure of claim 16, further comprising a die, the die having a feed port and a corresponding element receiving space which are in communication with each other, the joining element being disposed in the die and connected to the corresponding element receiving space, wherein a plastic liquid is introduced into the feed port and the corresponding element receiving space so as for the corresponding element to be fitted to the joining element.

18. The fastener structure of claim 17, wherein the die is pressed against the joining element to stop the plastic liquid introduced into the corresponding element receiving space from overflowing, flowing into or entering the joining element.

19. The fastener structure of claim 16, wherein the first inner engaging portion of the corresponding element is a resilient plastic element, such that the first inner engaging portion expands or stretches to become larger than or as large as the outer engaging portion when the first inner engaging portion of the corresponding element is movably engagingly-connected to the outer engaging portion of the fixing element, and the first inner engaging portion bounces and movably engagingly-connects with the outer engaging portion of the fixing element after the first inner engaging portion has passed the outer engaging portion.

20. The fastener structure of claim 16, further comprising a fixing element movably fitted to the corresponding element or the joining element.
